(19) United States
(12) Patent Application Publication
(10) Pub. No.: US 2006/0048881 A1
(43) Pub. Date: Mar. 9, 2006

(54) Laser-assisted placement of veiled composite material

(76) Inventors: Richard B. Evans, Maple Valley, WA (US); Stanley A. Lawton, Clayton, MO (US)

Correspondence Address: KLEIN, O'NEILL & SINGH, 2 PARK PLAZA, SUITE 510, IRVINE, CA, 92614, US

(21) Appl. No.: 10/936,175

(22) Filed: Sep. 8, 2004

(51) Int. Cl. B29C 65/00; B32B 37/00

(52) U.S. Cl. 156/64; 156/272.2

(57) ABSTRACT

A method of forming preform structures from fiber composite materials in an automated tape placement process, for subsequent resin infusion and heating. Pulsed laser radiation is directed into a nip region of a compaction roller during formation of a composite preform structure to selectively heat discrete areas on a resin veil of thermoplastic to an incoming fiber tape material and a surface of a substrate, to more precisely control tacking of the resin veil of thermoplastic to the fiber tape and the surface of a substrate in predetermined locations.

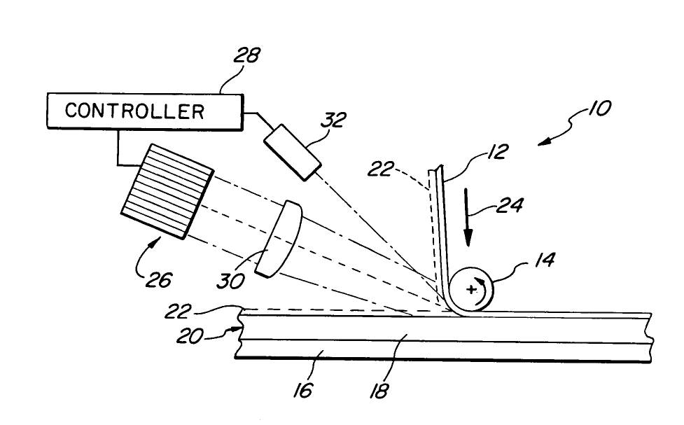

### BACKGROUND OF THE INVENTION

1. Field of the Invention

This invention generally relates to the manufacture of composite materials and, more particularly, to a process of automated tape placement to manufacture preform structures from composite materials utilizing a resin veil that is selectively spot tacked to fiber tapes or tows, by the use of pulsed laser radiation.

2. Description of the Prior Art

It is known to form high-performance composite materials built of alternating layers of unidirectional reinforcing fibers to form high strength and lightweight materials for use in aerospace and other industries. Such composite materials may be continuously and more affordably manufactured using automated layup of the composite materials. The final composite materials may be produced using what are referred to as prepregs or preforms. When using preforms, continuous and increased speed of fabricating machines and reduced cost of fabrication is obtained if the alternating layers of reinforcing fibers do not move or shift and more accurate control of heating and subsequent adhesion of the composite tape plies is maintained. In particular, when using some resin infusion methods, such as a controlled atmospheric pressure infusion to obtain autoclave-level fiber volumes in a finally fabricated structure starting with a preform, increased fusion rates may be achieved during infusion of the preforms by improving the permeability between the alternating layers to prevent the inhibition of the resin flow during the pressure infusion process. Prevention of movement and shift of the tape layers as well as improvement in the permeability of the interlayer may be obtained by better control of adhesion between tape layers and the interlayer during manufacture of the preform.

In a known method of producing composite material structures, dry preforms are first manufactured by securing together tapes or tows of fiber material using a permeable interlayer comprising a spider-web-like veil of thermoplastic resin, which is heat bonded and stitched to at least one layer of a fabric tow. The fabricated preforms are then heated and cured in a resin infusion process. The resin veil used stabilizes the tows and acts as a thermoplastic toughener when melted during the subsequent heating and curing. However, known hot gas torches used to provide heating of the tows and in heat bonding the resin veil to the tows are not precise enough to properly tack the thermoplastic resin veil to the tows, except at very low lay down rates.

Furthermore, the hot gas torches used in the known methods blow the fibers in the tows, which fibers are loosely held by the resin veil, thus causing the fibers to spread or bunch, resulting in non-uniform placement of the fibers in the composite material. Additionally, as mentioned above, the hot gases are imprecise and produce non-selective heating of the materials, usually resulting in 100% of the resin veil being heated and subsequently melted. This 100% heating of the resin veil causes problems, such as decreasing permeability by the non-selective melting of the thermoplastic resin, which blocks many potential migration paths during subsequent resin infusion. This blocking of the migration paths inhibits rapid resin infusion and could result in composite materials having lower fiber volumes, thus resulting in reduced strength composite structures and higher infusion costs. Therefore, gas torches are not a viable alternative to tack tows and resin veils, particularly in an automated tape placement apparatus and/or method.

U.S. Pat. No. 6,451,152 to Holmes et al. discloses a method of forming composite articles by guiding a composite tape material through a compaction region where the tape material is pressed onto a substrate, and heating the tape and substrate ahead of the compaction region by irradiating opposing surfaces of the tape and substrate with a laser diode array to produce a continuous tack line across the composite material being formed. The patent to Holmes et al., however, fails to disclose or teach the concept of modulating the laser diode array rapidly on and off to form discrete tack points. Further-more, it does not address the use of a laser diode array to selectively heat discrete points on a resin veil to provide spot tacks between material layers at predetermined locations. Nor does it address how spot tacking could be made between layers during automated tape placement of a preform structure that is subsequently used in a resin infusion process.

Therefore, there exists a need in the art for an improved method for the automated tape formation of preforms by the use of pulsed laser radiation from a laser diode array to form discrete tack points on fiber tapes or tows held together by a permeable resin veil during compaction.

### SUMMARY OF THE INVENTION

It is, therefore, a general object of the present invention to provide an improved method of forming composite materials. It is a particular object of the present invention to provide an improved method of rapidly forming composite materials by the use of laser radiation. It is a further particular object of the present invention to provide an improved method of forming preforms from composite materials by the use of pulsed laser radiation directed into the nip region of a compaction roller. It is yet another particular object of the present invention to provide an improved method of forming preform structures in an automated tape placement process wherein pulsed laser radiation is directed into the nip region of a compaction roller to selectively heat discrete areas of a resin veil. And, it is a still further yet another particular object of the present invention to provide an improved method of forming preform structures in an automated tape placement process wherein pulsed laser radiation from one or more laser diodes is directed into the nip region of a compaction roller to selectively spot tack predetermined discrete areas of a resin veil to carbon-fiber tapes.

These and other objects and advantages of the present invention are achieved by providing a method of forming preform structures from fiber composite materials in an automated tape placement process. A resin veil of thermoplastic is introduced between layers of fiber tape and pulsed laser radiation is directed into a nip region of a compaction roller during formation of a composite preform structure to selectively heat discrete areas on the resin veil, to more precisely control tacking of the resin veil to the fiber tapes in predetermined locations.

### BRIEF DESCRIPTION OF THE DRAWING

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawing, in which:

The sole FIGURE is a schematic side view showing a preferred embodiment of a method of the present invention.

### DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to describe an improved method of automated fabrication of preform structures from composite materials utilizing a permeable spider-web-like resin veil of thermoplastic material to hold together fiber tape or tows, such as carbon-fiber tows. The resin veil is formed as an interlayer made of spunbonded, spunlaced or mesh fabric thermoplastic fibers and is discretely heated at selected points by pulsed laser radiation from one or more lasers. The lasers are preferably diode lasers supported in one or more arrays, in any desired configuration and manner, for example in a head on an automated tape placement machine, to selectively spot tack the resin veil to the fiber tows, or to an integrated veil/tape product form, to allow fabrication by automated tape placement of large preform structures, such as aircraft parts, or the like, for subsequent resin infusion.

Turning now to the drawing, there shown is a currently preferred embodiment of a method of the present invention for forming preform composite structures in an automated placement machine, with a compaction area or nip-point area generally indicated at 10. As explained in U.S. Pat. No. 6,451,152, the disclosure of which is incorporated herein in its entirety by this reference thereto, an automatic tape placement apparatus includes a placement head to apply fiber tape or tows onto a substrate through computer-controlled manipulation of the placement head and movement of either the placement head or the substrate such that the material is continuously fed and guided onto the substrate as the head relatively moves over the substrate surface.

In one aspect of the present invention, an incoming fiber tow 12 is guided over a compaction roller 14 and onto a substrate 16. The substrate 16 may take any desired form, and may include a template 18 and a fiber composite 20 covering the template. The fiber composite 20 may take any desire form, such as one or more previously laid layers of fiber tape with an interlayer, or a tow 12 and may have a spider-web veil of resin 22 previously applied to, i.e., as an integral part of the fiber composite 20, or fed onto the top or upper surface of the fiber composite. Or, the spider-web veil of resin may be fed into the nip point separately, or with the incoming tow 12, The compaction roller 14 is urged downwardly, in the direction of arrow 24, so as to press the incoming fiber tow 12 into or onto the resin veil 22 and/or onto the top surface of the substrate 20. The compaction roller 14 rolls along or over the new top surface of the fiber tow 12 applied to the substrate 20 as relative movement is provided between the roller and the substrate, and the resin veil 22 and fiber tow are continuously applied to or fed into the nip point and pressed onto the top surface of the substrate. Adhesion of the fiber tow 12 to the resin veil 22 and top surface of the substrate 20 is accomplished by the selective heating of discrete areas on the resin veil, as explained more fully below.

In accordance with one aspect of the present invention, the resin veil 22 is selectively heated in discrete areas by pulsed radiant energy from one or more lasers 26. The one or more lasers 26 are preferably diode lasers placed in one or more arrays, which are pulsed on only long enough to provide a predetermined length(s) of tacking on the materials. The pulsed light from the laser array 26 can be guided and focused by an imaging system 30 having one or more lenses or similar means to focus the light from the pulsed laser array. The heating of the resin veil 22 by the laser array 26 may be monitored by a temperature sensor 32, and the rapid on and off of the laser array modulated, as required, by a controller 28, or other similar means. The controlled, rapid modulation of the laser array 28 allows the resin veil to be selectively spot tacked in specific, predetermined locations. For example, the spacing for the spot tacking of the resin veil 22 to the tow 12 and surface of the substrate 20, or one layer of resin veil composite tow product to the next layer, is varied as needed. In flat regions of the substrate 20 the spacing may be long or spread apart, while in contoured regions the spot tacks may be placed closer together. Essentially, the bulk factor of the materials being used to fabricate preforms can be tailored by the varying spot tack density made possible by the rapid on/off control of the laser diode 26. Furthermore, the present invention provides for the accurate aiming or direction of pulsed laser light at precisely controlled areas on the resin veil 22, to tack together layers of fiber tape, such as carbon-fiber tape.

The size and spacing of the discrete areas being spot tacked and the duration and strength of the pulse of the laser array 26 to form such tack points is precisely controlled. The actual control depends on a number of variables, such as: the size, shape, and specific materials being tacked; the speed of the travel of the materials through the compaction point; the modulation of the laser array 26; and the power density of the laser light reaching the resin veil, directly or through the imaging system 30. For example, using a 4 kW device having four diode arrays, each capable of 1 kW operation, and scanning across carbon-fiber tape with a resin veil thereon or between to be tacked, with the laser array at a predetermined distance and heating an approximately 0.6 square centimeter area of the compaction region, it can be demonstrated that the degree of tack depends directly on the power density. The following Table I shows the response of the material for various variables of laser power (in percentage of full power), pulse frequency and pulse duration used during a number of runs to tack the resin veil to carbon-fiber layers at a rate of about 50 to 90 inches per minute:

TABLE I

| Power | Frequency | Duration | |
|---|---|---|---|
| (%) | (Hz) | (Ms) | RESULTS |
| 10 | 10 | 50 | No tack |
| 10 | 10 | 100 | No tack |
| 15 | 20 | 25 | Tacked |
| 15 | 10 | 50 | Good tack |
| 15 | 10 | 100 | Good tack |
| 17 | 20 | 25 | Tacked |
| 20 | 20 | 25 | Smokes a little |
| 20 | 10 | 100 | Smoke |
| 25 | 10 | 100 | Continual Smoke from nip region |

Subsequent measurements of the laser power indicate that laser power densities per pulse of approximately 30 watt/cm² to approximately 80 watt/cm² will be sufficient to cause the resin veil to tack to the carbon-fiber tape, while higher powers will cause this particular material to smoke. With the particular optical arrangement used, tacking was not achieved for lower power densities; however, tacking could be achieved with lower laser power by modifying the laser and/or the optical configuration.

The spacing between tack locations is controlled in any desired manner, such as by the use of placement seed or by modifying the laser pulse rate. The laser pulse rate may be controlled in any manner well known to those skilled in the art, such as by use of an external oscillator and/or the control of the controller to determine timing and spacing of the pulses.

Thus, there has been described an improved method for the automated tape placement using pulsed laser radiation from a laser diode array to form discrete tack points in predetermined locations on a resin veil to hold together fiber tapes or tows to enable large preform composite structures to be continuously constructed in an automated process, prior to resin infusion and heating.

Those skilled in the art will appreciate that various adaptations and modifications of the just-described preferred embodiments may be configured without departing from the scope and spirit of the invention. Therefore, it is to be understood that, within the scope of the appended claims, the invention may be practiced other than as specifically described herein.

What is claimed is:

1. A method of forming preform structures from fiber composite materials in an automated tape placement process, comprising:
guiding a fiber tape onto a surface of a substrate having a resin veil of thermoplastic at a compaction region;
pressing the fiber tape into the resin veil of thermoplastic and the surface of the substrate at the compaction region; and
heating the resin veil of thermoplastic at discrete points by pulsed laser radiation from at least one laser directed into the compaction region to selectively tack the resin veil of thermoplastic to the fiber tape and the surface of the substrate.

2. The method of claim 1 wherein the resin veil of thermoplastic is an integral part of a composite tape and the at least one laser is a laser diode array that is pulsed by a controller to precisely control tacking of the resin veil of thermoplastic to the fiber tape and the composite tape in predetermined locations.

3. The method of claim 2 wherein the fiber tape is guided around a compaction roller at a nip point where it is pressed into the resin veil of thermoplastic and the surface of the substrate and the resin veil of thermoplastic is selectively adhered to predetermined discrete areas on the fiber tape and the surface of the substrate by the pulsing light from the laser diode array after the pulsing light passes through an imaging system.

4. The method of claim 3 wherein the imaging system is changed to vary the size of a burn pattern on discrete areas of the resin veil of thermoplastic being spot tacked.

5. The method of claim 4 wherein the pulsing light from the laser diode array is controlled by a controller to precisely tack the resin veil of thermoplastic to the fiber tape and the surface of the substrate.

6. The method of claim 1 wherein the resin veil of thermoplastic is guided onto the surface of the substrate and the at least one laser is a laser diode array that selectively spot tacks the resin veil of thermoplastic to the fiber tape and the surface of the substrate in predetermined locations.

7. The method of claim 6 wherein the fiber tape is guided around a compaction roller at a nip point where it is pressed into the resin veil of thermoplastic and the surface of the substrate and the resin veil of thermoplastic is selectively adhered to predetermined discrete areas on the fiber tape and the surface of the substrate by the pulsing light from the laser diode array after the pulsing light passes through an imaging system.

8. The method of claim 7 wherein the imaging system is changed to vary the size of a burn pattern on discrete areas of the resin veil of thermoplastic being spot tacked.

9. The method of claim 8 wherein the pulsing light from the laser diode array is controlled by a controller to precisely tack the resin veil of thermoplastic to the fiber tape and the surface of the substrate.

10. A method of forming preform structures from fiber composite materials in an automated tape placement process, comprising:
introducing a resin veil of thermoplastic to a surface of a substrate;
guiding a fiber tape over a compaction roller at a compaction region and onto the resin veil of thermoplastic;
pressing the fiber tape into the resin veil of thermoplastic and the surface of the substrate by the compaction roller at the compaction region; and
heating the resin veil of thermoplastic at discrete points by pulsing light from a laser array directed into the compaction region by an imaging system to selectively tack the resin veil of thermoplastic to the fiber tape and the surface of the substrate.

11. The method of claim 10 wherein the resin veil of thermoplastic is an integral part of the substrate and the laser array is a laser diode array that selectively spot tacks the resin veil of thermoplastic to the fiber tape and the surface of the substrate in predetermined locations.

12. The method of claim 11 wherein the pulsing light from the laser diode array is controlled by a controller to precisely tack the resin veil of thermoplastic to the fiber tape and the surface of the substrate.

13. The method of claim 12 wherein the imaging system is changed to vary the size of a burn pattern on discrete areas of the resin veil of thermoplastic being spot tacked.

14. A method of forming large preform structures from fiber composite materials in an automated tape placement process, comprising:
continuously securing a resin veil of thermoplastic to a surface of a substrate;
continuously guiding the substrate into a compaction region;
continuously guiding a fiber tape over a compaction roller at the compaction region and onto the resin veil of thermoplastic;
continuously pressing the fiber tape into the resin veil of thermoplastic and the surface of the substrate by the compaction roller at the compaction region; and
selectively heating the resin veil of thermoplastic at discrete points by controlling pulsing light from a laser diode array by a controller and directing the pulsing light into the compaction region by an imaging system to spot tack the resin veil of thermoplastic to the fiber tape and the surface of the substrate at predetermined locations.

15. A method of forming preform structures from fiber composite materials in an automated tape placement process, comprising:
guiding a fiber tape onto a surface of a substrate at a compaction region;
providing a resin veil of thermoplastic between the fiber tape and the surface of the substrate at a compaction region;
pressing the fiber tape into the resin veil of thermoplastic and the surface of the substrate at the compaction region; and
heating the resin veil of thermoplastic at discrete points by pulsed laser radiation from at least one laser directed into the compaction region to selectively tack the resin veil of thermoplastic to the fiber tape and the surface of the substrate.

16. The method of claim 15 wherein the resin veil thermoplastic material is guided onto the surface of the substrate and the at least one laser is a laser diode array that is pulsed by a controller to precisely control tacking of the resin veil of thermoplastic to the fiber tape and the surface of the substrate in predetermined locations.

17. The method of claim 15 wherein the resin veil of thermoplastic material is an integral part of the substrate and the at least one laser is a laser diode array that selectively spot tacks the resin veil of thermoplastic to the fiber tape and the surface of the substrate in predetermined locations.

18. The method of claim 17 wherein the fiber tape is guided around a compaction roller at a nip point where it is pressed into the resin veil of thermoplastic and the surface of the substrate and the resin veil of thermoplastic is selectively adhered to predetermined discrete areas on the fiber tape and the surface of the substrate by the pulsing light from the laser diode array after the pulsing light passes through an imaging system.

19. The method of claim 18 wherein the fiber tape is a carbon-fiber tape and the imaging system is changed to change the size of a burn pattern on discrete areas of the resin veil of thermoplastic being spot tacked.

20. The method of claim 18 wherein the pulsing light from the laser diode array is controlled by a controller to precisely tack the resin veil of thermoplastic to the fiber tape and the surface of the substrate in predetermined discrete areas of approximately 0.6 square centimeters.
